(19) United States
(12) Patent Application Publication
(10) Pub. No.: US 2018/0184077 A1
(43) Pub. Date: Jun. 28, 2018

(54) IMAGE PROCESSING APPARATUS, METHOD, AND STORAGE MEDIUM

(71) Applicant: CANON KABUSHIKI KAISHA, Tokyo (JP)

(72) Inventor: Yuji Kato, Yokohama-shi (JP)

(21) Appl. No.: 15/849,478

(22) Filed: Dec. 20, 2017

(30) Foreign Application Priority Data
Dec. 28, 2016 (JP) 2016-256606

(51) Int. Cl. H04N 5/232; H04N 13/00

(52) U.S. Cl. CPC H04N 13/0409; H04N 13/0007; H04N 5/23296

(57) ABSTRACT

An image processing apparatus configured to generate a display image to be displayed in a display apparatus from a parallax image includes a first acquiring unit configured to acquire posture information of the display apparatus, a second acquiring unit configured to acquire a parallax amount in the parallax image, an adjusting unit configured to adjust postures of virtual cameras disposed virtually on viewpoints corresponding to the parallax image based on the posture information of the display apparatus and the parallax amount in the parallax image, and a generating unit configured to generate the display image from the parallax image based on the posture information of the display apparatus and adjusted postures of the virtual cameras.

### BACKGROUND

### Field of the Disclosure

The present disclosure generally relates to image processing and, more particularly, to image processing apparatuses, image processing methods, and storage mediums.

### Description of the Related Art

There is known a display apparatus that displays a three-dimensional (3D) image (video image) by using a parallax image composed of a left-eye image and a right-eye image. In such a display apparatus, the following problem is known. Specifically, when a viewer views a 3D image with his/her head tilted to the right or the left, parallax is produced in a direction different from the direction of a line segment connecting the eyes of the viewer. Such parallax may cause eye fatigue for the viewer or may make the fusion of the parallax image difficult.

The technique disclosed in Japanese Patent Laid-Open No. 2012-244453 is one of the techniques for reducing the parallax described above. According to Japanese Patent Laid-Open No. 2012-244453, the display positions of the right and left video images (display images) are each shifted in accordance with the tilt of the viewer's head, and the display images are displayed on a planar 3D display. According to Japanese Patent Laid-Open No. 2012-244453, the image display positions are shifted in accordance with the tilt of the viewer's head acquired with a posture sensor provided in 3D glasses.

However, when an image (video image) is displayed in a head mounted display, there is a case in which processing for largely deforming the image needs to be carried out when the image is displayed (for example, an image captured by a fisheye camera, a 360-degree spherical image, or the like is displayed). If an image that has been subjected to the processing including large deformation is simply shifted, a large portion of the peripheral region of the display image is trimmed, and thus the viewing angle obtained when the image is viewed with the head mounted display is reduced. In addition, if the display image is simply shifted when the distortion correction of the eyepiece lens in the head mounted display is employed along with the deformation processing, the distortion of the eyepiece lens cannot be corrected properly.

### SUMMARY

The present disclosure is related to providing image processing for generating a display image with appropriate parallax without reducing the viewing angle.

An image processing apparatus according to one or more aspects of the present disclosure is an image processing apparatus configured to generate a display image to be displayed in a display apparatus from a parallax image, and the image processing apparatus includes a first acquiring unit configured to acquire posture information of the display apparatus, a second acquiring unit configured to acquire a parallax amount in the parallax image, an adjusting unit configured to adjust postures of virtual cameras disposed virtually on viewpoints corresponding to the parallax image based on the posture information of the display apparatus and the parallax amount in the parallax image, and a generating unit configured to generate the display image from the parallax image based on the posture information of the display apparatus and adjusted postures of the virtual cameras.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of an image processing apparatus according to one or more aspects of the present disclosure.

FIG. 2A is a functional block diagram of the image processing apparatus according to one or more aspects of the present disclosure.

FIG. 2B illustrates an example of a head mounted display according to one or more aspects of the present disclosure.

FIG. 3 is a flowchart illustrating a flow of processing in the image processing apparatus according to one or more aspects of the present disclosure.

FIGS. 4A and 4B illustrate examples of a 360-degree spherical image having parallax according to one or more aspects of the present disclosure.

FIG. 5 illustrates an example of a display image according to one or more aspects of the present disclosure.

FIGS. 6A and 6B illustrate examples of the coordinates and the rotation of a display according to one or more aspects of the present disclosure.

FIG. 7 illustrates the coordinate system of an image to be displayed on a display according to one or more aspects of the present disclosure.

FIG. 8 illustrates an example of a display image obtained when the viewer tilts the head (neck) according to one or more aspects of the present disclosure.

FIG. 9 illustrates a case in which a display image is simply shifted.

FIG. 10 illustrates an example of adjusting the posture of a virtual camera according to one or more aspects of the present disclosure.

FIG. 11 is a flowchart illustrating a flow of display image generating processing according to one or more aspects of the present disclosure.

FIG. 12 illustrates the distortion of a lens on a display image according to one or more aspects of the present disclosure.

FIG. 13 illustrates a pixel position on the coordinate system with its origin lying on the position of an eye according to one or more aspects of the present disclosure.

### DESCRIPTION OF THE EMBODIMENTS

Hereinafter, one or more aspects of the present disclosure will be described with reference to the drawings. It is to be noted that the following exemplary embodiments are not intended to limit the present disclosure and that not all the combinations of the features described in one or more aspects of the present disclosure are essential in the present disclosure. Identical configurations are given identical reference characters in the description.

Described in one or more aspects of the present disclosure is an image processing apparatus that displays an image with appropriate parallax without reducing the viewing angle even if the viewer tilts the head when a parallax image composed of a left-eye image and a right-eye image is displayed in a display apparatus for displaying a stereoscopic image, such as a head mounted display.

### Hardware Configuration of Image Processing Apparatus

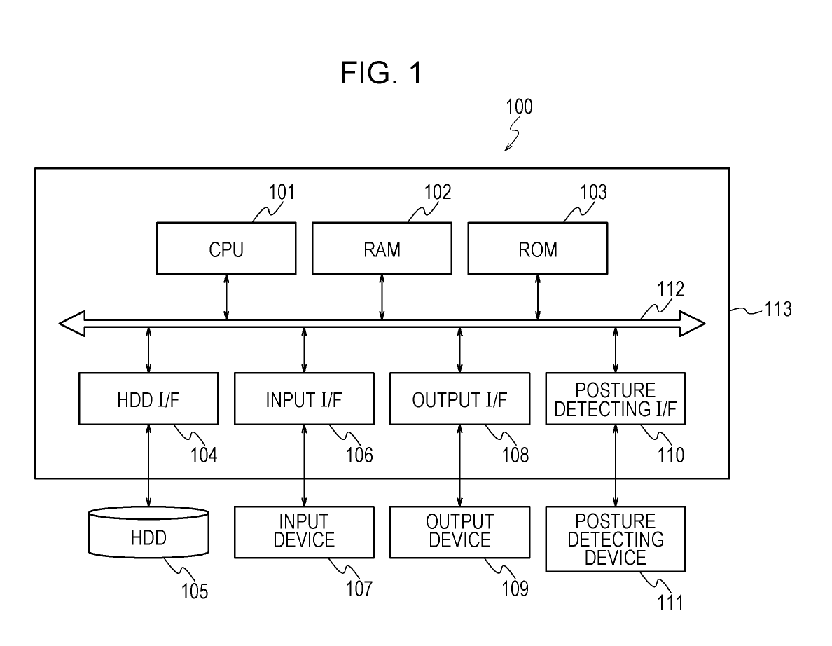

First, a configuration example of an image processing system that includes an image processing apparatus according to one or more aspects of the present disclosure will be described with reference to FIG. 1.

As illustrated in FIG. 1, an image processing system 100 includes a central processing unit (CPU) 101, a random-access memory (RAM) 102, a read-only memory (ROM) 103, a hard disk drive (HDD) interface (I/F) 104, an HDD 105, an input I/F 106, and an input device 107. The image processing system 100 further includes an output I/F 108, an output device 109, a posture detecting I/F 110, and a posture detecting device 111. The CPU 101, the RAM 102, the ROM 103, the HDD 105, the input device 107, the output device 109, and the posture detecting device 111 are interconnected via a bus 112 and the associated I/Fs (104, 106, 108, and 110). An image processing apparatus 113 according to one or more aspects of the present disclosure is included in the image processing system 100, and the image processing apparatus 113 includes the CPU 101, the RAM 102, the ROM 103, the HDD I/F 104, the input I/F 106, the output I/F 108, and the posture detecting I/F 110.

The ROM 103 and the HDD 105 store program(s) for the operation of the image processing apparatus 113.

The HDD I/F 104 connects the HDD 105 to the image processing apparatus 113. The HDD I/F 104 may be an interface of serial ATA (SATA) or the like, for example. The HDD 105 is an example of a secondary storage device to be connected to the image processing apparatus 113. In addition to an HDD (or in place of an HDD), a different secondary storage device, such as an optical disc drive, may be connected to the image processing apparatus 113. ATA stands for Advanced Technology Attachment.

The CPU 101, which may include one or more processors and one or more memories, may execute the program(s) stored in the ROM 103 and (or) the HDD 105 while using the RAM 102 as a work memory to control each configuration unit of the image processing apparatus 113 via the system bus 112. Thus, the various processes described later are executed.

The CPU 101 can read out data from the HDD 105 and can write data into the HDD 105 via the HDD I/F 104. The CPU 101 can expand the data stored in the HDD 105 onto the RAM 102. The CPU 101 can store the data expanded on the RAM 102 into the HDD 105. The CPU 101 can execute the programs expanded on the RAM 102.

The input I/F 106 may connect the input device 107, such as a keyboard, a mouse, a digital camera, or a scanner, to the image processing apparatus 113. The input I/F 106 may be, for example, a serial bus interface compliant with the standard such as USB or IEEE 1394. The CPU 101 can retrieve data from the input device 107 via the input I/F 106.

The output I/F 108 may connect the output device 109 to the image processing apparatus 113. The output device 109 may include an image display surface. The output device 109 may be a head mounted display in one or more aspects of the present disclosure. The head mounted display may include an eyepiece lens. The output I/F 108 may be, for example, a video out interface compliant with the standard such as DVI or HDMI (registered trademark). DVI stands for Digital Visual Interface. HDMI stands for High Definition Multimedia Interface. The CPU 101 can transmit data to the output device 109 via the output I/F 108 to cause the output device 109 to display the data.

The posture detecting I/F 110 may connect the posture detecting device 111, such as an acceleration sensor or an angular velocity sensor, to the image processing apparatus 113. The posture detecting I/F 110 may be, for example, a serial bus interface compliant with the standard such as USB or IEEE 1394. In one or more aspects of the present disclosure, the posture detecting device 111 may be mounted to the image display surface of the output device 109 or to the vicinity thereof. The CPU 101 can retrieve posture information of the image display surface of the output device 109 from the posture detecting device 111 via the posture detecting I/F 110. The posture information of the image display surface of the output device 109 can also be input to the CPU 101 with a mouse, a keyboard, a camera, or the like.

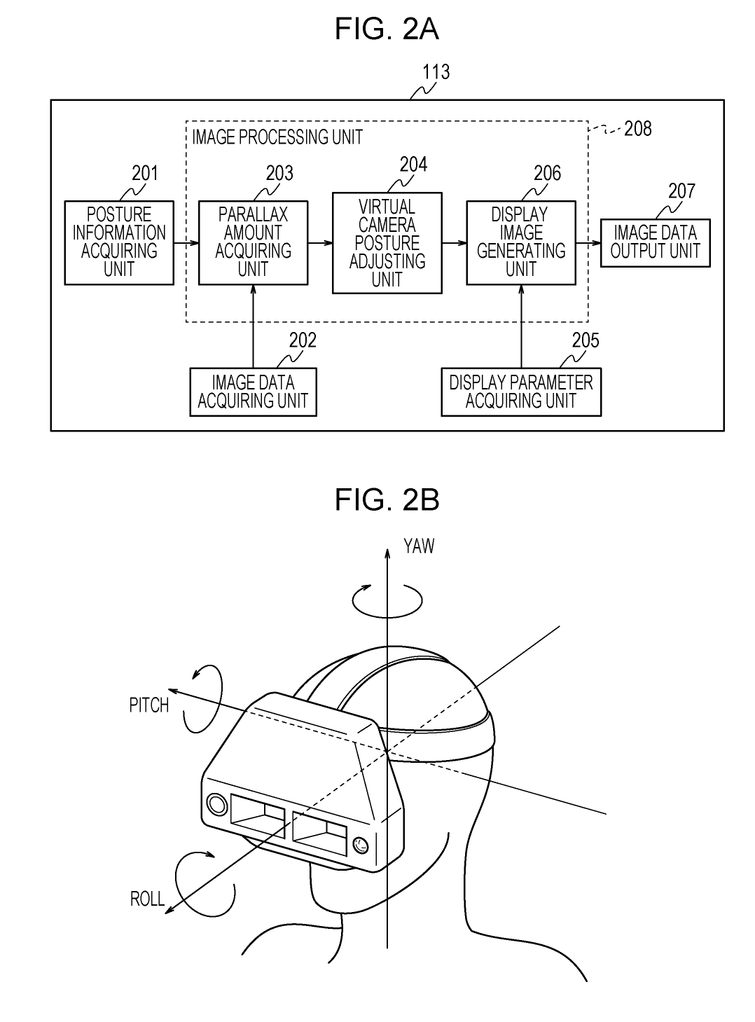

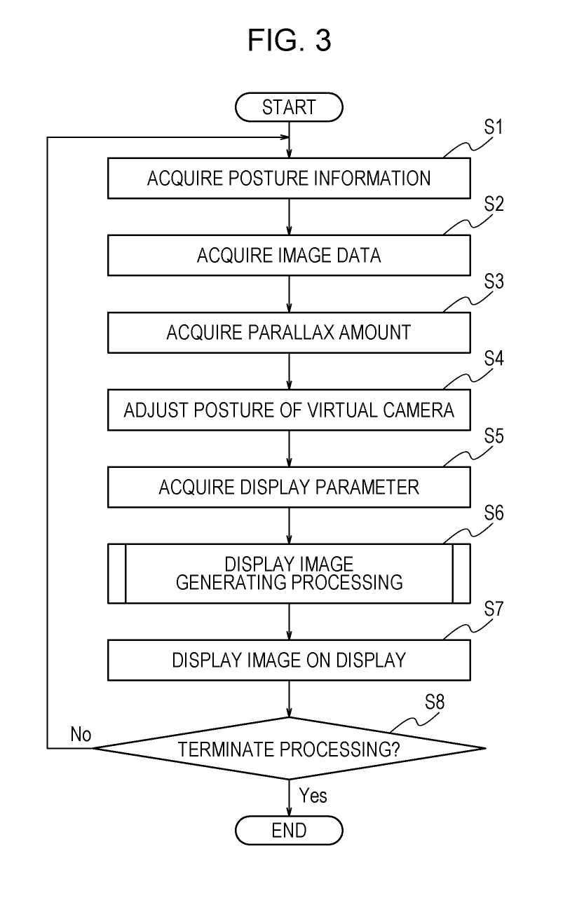

Hereinafter, the flow of the processing carried out by the image processing apparatus 113 according to one or more aspects of the present disclosure will be described with reference to FIGS. 2A, 2B, and 3.

### Functional Configuration of Image Processing Apparatus

FIG. 2A is a block diagram illustrating a functional configuration of the image processing apparatus 113 according to one or more aspects of the present disclosure. The image processing apparatus 113 includes a posture information acquiring unit 201, an image data acquiring unit 202, a parallax amount acquiring unit 203, a virtual camera posture adjusting unit 204, a display parameter acquiring unit 205, a display image generating unit 206, and an image data output unit 207. The parallax amount acquiring unit 203, the virtual camera posture adjusting unit 204, and the display image generating unit 206 constitute an image processing unit 208. The processing and the operation of each functional unit illustrated in FIG. 2A will be described with reference to the flowchart illustrated in FIG. 3. A virtual camera is a camera disposed virtually on the viewpoint corresponding to a parallax image.

The units described throughout the present disclosure are exemplary and/or preferable modules for implementing processes described in the present disclosure. The modules can be hardware units (such as circuitry, a field programmable gate array, a digital signal processor, an application specific integrated circuit or the like) and/or software modules (such as a computer readable program or the like). The modules for implementing the various steps are not described exhaustively above. However, where there is a step of performing a certain process, there may be a corresponding functional module or unit (implemented by hardware and/or software) for implementing the same process. Technical solutions by all combinations of steps described and units corresponding to these steps are included in the present disclosure.

FIG. 2B illustrates the roll, the pitch, and the yaw of the posture of the head mounted display.

The CPU 101 illustrated in FIG. 1 reads out the program(s) stored in the ROM 103 or the HDD 105 and executes the program(s) while using the RAM 102 as a work area to thus function as the functional blocks illustrated in FIG. 2. In addition, images handled in one or more aspects of the present disclosure are 360-degree spherical images.

### Processing of Image Processing Apparatus

FIG. 3 is a flowchart illustrating the flow of the processing carried out by the image processing apparatus 113 according to one or more aspects of the present disclosure.

First, in S1, the posture information acquiring unit 201 (FIG. 2) acquires posture information from the posture detecting device 111 (FIG. 1) or the input device 107 (FIG. 1). The posture information acquiring unit 201 may acquire posture information that has been stored in the RAM 102 or the HDD 105. The posture information is the data that indicates the posture of the head mounted display and is described with the use of a 3×3 rotation matrix R, the roll, the pitch, and the yaw in one or more aspects of the present disclosure. The posture information acquiring unit 201 outputs the acquired posture information to the parallax amount acquiring unit 203.

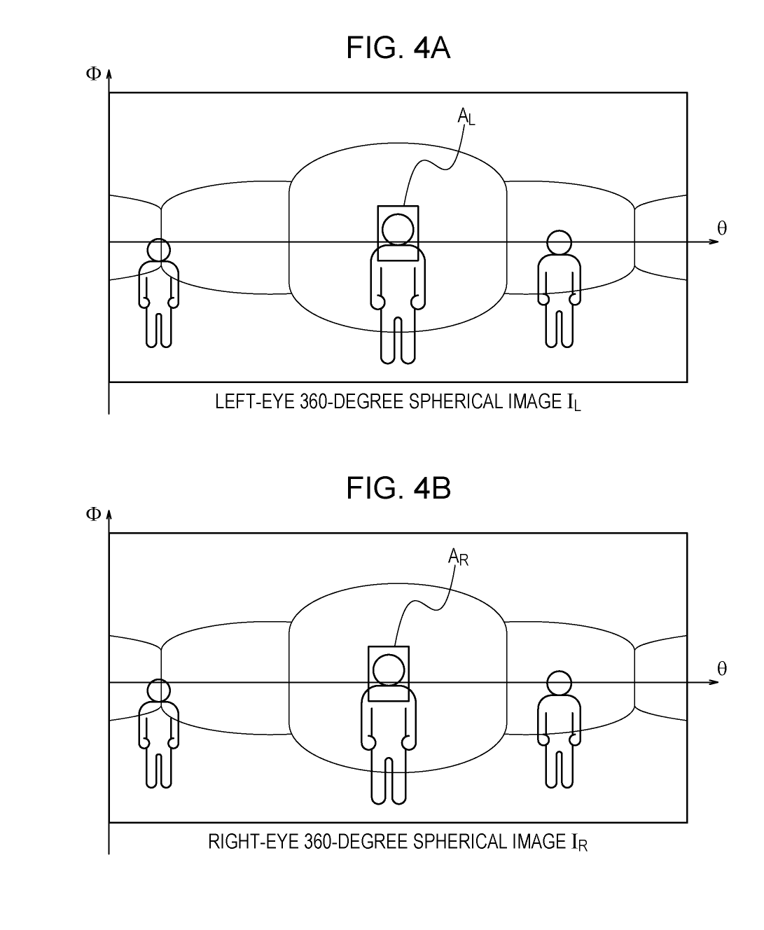

In S2, the image data acquiring unit 202 acquires image data to be displayed next from the HDD 105 or the input device 107. The image data acquiring unit 202 outputs the acquired image data to the parallax amount acquiring unit 203. Of the acquired image data, the image data to be displayed for the left eye is designated by I_{L}, and the image data to be displayed for the right eye is designated by I_{R} (FIGS. 4A and 4B). As stated above, the images dealt with in one or more aspects of the present disclosure are 360-degree spherical images.

Examples of 360-degree spherical images are illustrated in FIGS. 4A and 4B. Image data of a 360-degree spherical image preserves the colors of incident light rays oriented in all directions. The horizontal axis of the image data represents the azimuthal angle θ, and the range of the azimuthal angle θ is [0 2π]. The vertical axis represents the elevation angle φ, and the range of the elevation angle φ is [−π/2 π/2].

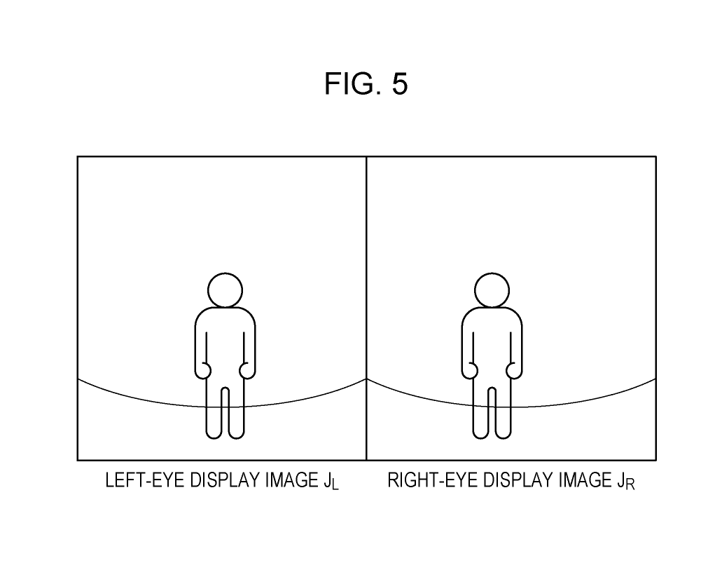

In S3 and thereafter, display images (display parallax image) as illustrated in FIG. 5 are created from the input image data (the acquired image data). The display images include a left-eye display image J_{L} to be presented to the left eye and a right-eye display image J_{R} to be presented to the right eye. The left-eye display image J_{L} and the right-eye display image J_{R} are images in which the distortion of the eyepiece lens has been corrected so that the left-eye display image J_{L} and the right-eye display image J_{R} can be viewed without distortion when viewed through the eyepiece lens.

In S3, the parallax amount acquiring unit 203 acquires an parallax amount between the image data I_{L} and the image data I_{R} in a region of interest on the basis of the posture information and the image data (or on the basis of the image data). The parallax amount acquiring unit 203 outputs the acquired parallax amount to the virtual camera posture adjusting unit 204.

In a head mounted display that displays a video image while following the movement of the head, the viewer looks around while moving the head, and thus the view is likely to focus on the center region in the field of view. Therefore, in one or more aspects of the present disclosure, the center regions in the field of view of the image data I_{L} and the image data I_{R} are set as the regions of interest, and the parallax amount thereof is acquired. The parallax amount may be acquired from a parallax map created in advance from the image data I_{L} and the image data I_{R} or may be acquired through a calculation.

When the parallax amount is acquired through a calculation, the coordinates indicated by the azimuthal angle θd and the elevation angle φd representing the posture of the head mounted display are set as the center of the field of view in the image data. A region of N×M pixels around the center of the field of view in the left-eye image data I_{L} is set as A_{L}. Then, the pixels around the center of the field of view in the right-eye image data I_{R} are scanned in the horizontal direction to carry out matching processing, and a region A_{R} with the highest similarity is obtained. This matching processing is template matching, for example. It suffices that the evaluation index of the similarity be able to evaluate the similarity between regions, such as SSD (Sum of Squared Difference) or SAD (Sum of Absolute Difference). The deviation amount between the center of the obtained region A_{R} and the center of the region A_{L} in the horizontal direction is designated as a parallax amount d in the target of interest (region of interest). Although the target of interest (region of interest) has been described as the center of the field of view in the image data, the parallax may be obtained with a region with the smallest distance in the image data, a region with the highest prominence, or a region specified manually serving as the region of interest.

In S4, the virtual camera posture adjusting unit 204 adjusts the postures of the right and left virtual cameras used to generate the right and left display images on the basis of the parallax amount acquired from the parallax amount acquiring unit 203 and the posture information. The virtual camera posture adjusting unit 204 outputs the information on the adjusted postures of the virtual cameras (posture information) to the display image generating unit 206. Herein, of the posture information, the amount of rotation (roll angle) α about an axis extending positively in the front direction of the head mounted display is used to adjust the postures of the virtual cameras.

### Roll of Head Mounted Display

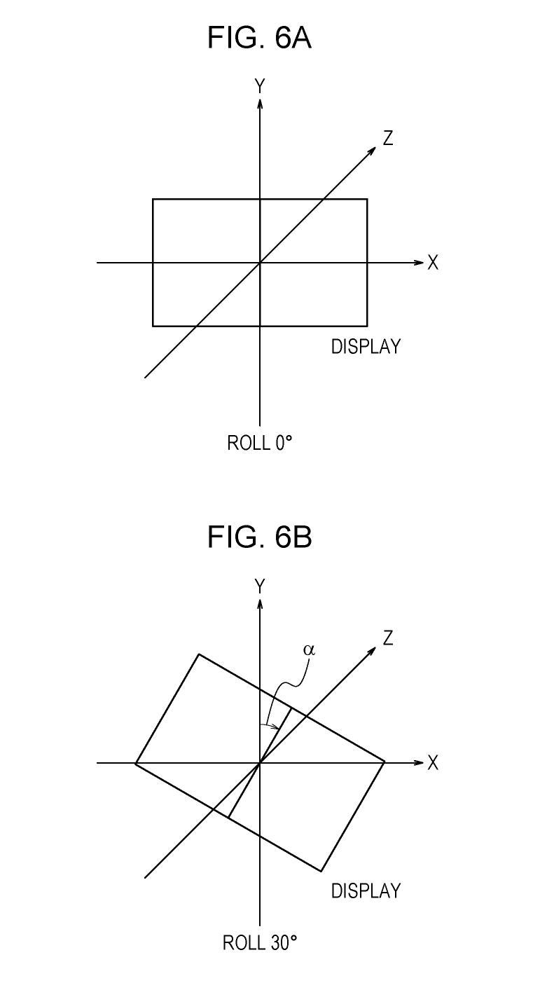

FIGS. 6A and 6B illustrate examples of the roll of the head mounted display. In FIGS. 6A to 9, 12 and 13, the image display surface of the head mounted display is indicated as DISPLAY. With regard to the coordinate system, the front direction is the positive direction of the Z-axis, the right direction is the positive direction of the X-axis, and the upward direction is the positive direction of the Y-axis. FIG. 6A illustrates a case in which the roll angle α is 0 degrees. When the roll angle α is 0 degrees, the Y-axis of the display is perpendicular to the ground surface, and the line segment connecting the eyes of the viewer lies in a plane crossing a certain point on the Y-axis (that is, the line segment is parallel to the X-axis or lies in a plane containing the X-axis). FIG. 6B illustrates a case in which the roll angle α is 30 degrees. In other words, FIG. 6B illustrates a state of the display held when the viewer has tilted the head to the right. The virtual cameras tilt in the same manner when the display is tilted.

### Coordinate System of Image Displayed on Display

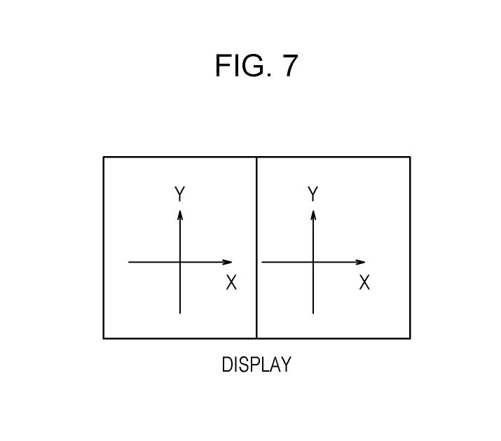

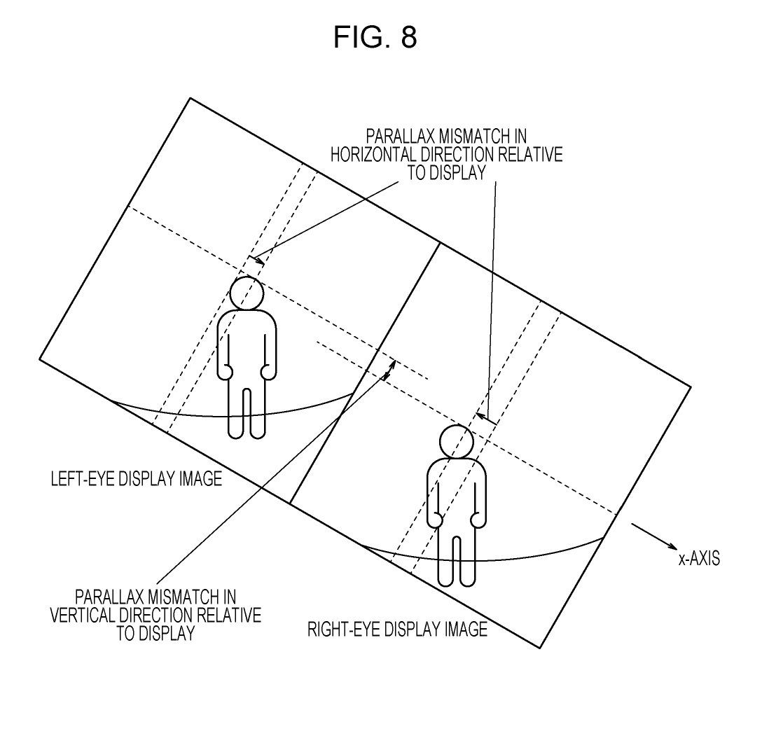

FIG. 7 illustrates the coordinate system of the image displayed on the display. The right direction of the display is the positive direction of the x-axis, and the upward direction is the positive direction of the y-axis. In the parallax image, the parallax is being produced in the horizontal direction. In order to view the parallax image with the head mounted display comfortably, the parallax may be present only in the x-axis direction of the display. However, if display images are generated and displayed simply on the basis of the posture information of the display, the parallax is produced in both the x-axis direction and the y-axis direction of the display in the displayed display images. For example, when the viewer tilts the head to the right, the positions of the eyes of the viewer become parallel to the x-axis of the display as illustrated in FIG. 8 (although the parallax is present in the horizontal direction relative to the ground surface). Thus, the parallax in the direction parallel to the eyes of the viewer (the widthwise direction of the display) is reduced (the two arrows directed inward in the x-axis direction), and the parallax is produced in the vertical direction of the display (y-axis direction) (the arrow directed in the heightwise direction of the display). In other words, the parallax is produced in the horizontal direction and in the vertical direction of the display. The sense of distance changes as the parallax in the horizontal direction is reduced, and the fusion becomes difficult as the parallax is produced in the vertical direction.

### Conventional Technique

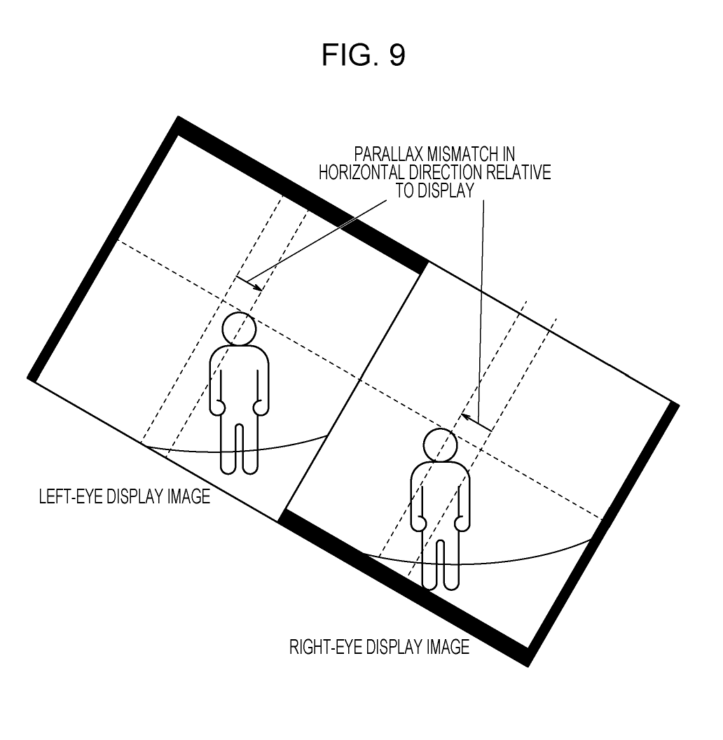

In a conventional technique, display images such as those illustrated in FIG. 8 are subjected to processing of shifting the display image in the up and down direction and in the right and left direction. To be more specific, as illustrated in FIG. 9, the parallax in the vertical direction is eliminated by shifting the display images in the up and down direction and the right and left direction of the display, and the parallax is produced in the horizontal direction. However, such shifting produces regions in the edges of the display in which the images cannot be displayed by the amount by which the images have been shifted, and the viewing angle is reduced (the solid black portions in FIG. 9). In addition, shifting the images produces a mismatch between the center of the eyepiece lens and the center position in the distortion correction, and the distortion cannot be corrected properly.

### Technique of the Present Disclosure

Accordingly, in one or more aspects of the present disclosure, the postures of the right and left virtual cameras are adjusted such that appropriate parallax is produced in the horizontal direction relative to the eyes of the viewer and the parallax in the vertical direction is eliminated in the region of interest, and thus an image with an appropriate parallax amount is presented without reducing the viewing angle.

For example, when the parallax is present in the vertical direction (y-axis direction) relative to the display, the virtual cameras are rotated by ΔΦ [radian] about the respective axes extending in the right and left direction of the virtual cameras to adjust the postures. When the parallax in the horizontal direction (x-axis direction) of the display is adjusted, the virtual cameras are rotated by Δθ [radian] about the respective axes extending in the up and down direction of the virtual cameras to adjust the parallax. Thus, an image in which the distortion is corrected properly and appropriate parallax is present can be displayed without narrowing the viewing angle (without reducing the viewing angle). Hereinafter, a method for calculating the amount of rotation of the virtual cameras will be described.

When the head is tilted as illustrated in FIG. 8 and the right eye is located lower than the left eye (0≤α≤π), the region of interest in the right-eye display image is displayed in an area lower than the appropriate location. In contrast, the region of interest in the left-eye display image is displayed in an area higher than the appropriate location. Thus, the right virtual camera is rotated downward in order to shift the right-eye display image upward and display the shifted display image, and the left virtual camera is rotated upward in order to shift the left-eye display image downward and display the shifted display image. When the left eye is located lower than the right eye (−π≤α<0), the right virtual camera is rotated upward in order to shift the right-eye display image downward and display the shifted display image, and the left virtual camera is rotated downward in order to shift the left-eye display image upward and display the shifted display image. In addition, the parallax in the x-axis direction of the display is reduced when the viewer tilts the head, and thus the postures of the right and left virtual cameras are rotated inward in order to shift the display images in the direction in which the parallax increases. The amount of rotation is determined such that the parallax amount d in the horizontal direction in the 360-degree spherical image cancels the parallax mismatch distributed in the vertical component and the horizontal component through the roll rotation. With regard to the widthwise direction of the display, the postures (azimuthal angles) of the virtual cameras are adjusted such that the parallax amount in the display images becomes equal to the parallax amount produced in the parallax image when the display is not tilted.

The amount of rotation (the amount of adjustment) Δθ_{L}, and ΔΦ_{L} of the left virtual camera and the amount of rotation Δθ_{R} and ΔΦ_{R} of the right virtual camera can be expressed through the following expressions.

The amount of rotation of the left virtual camera:

Δθ_{L}=Sign(cos α)×D/2×(1−|cos α|)

ΔΦ_{L}=−Dsin α/2

The amount of rotation of the right virtual camera:

Δθ_{R}=−Sign(cos α)×D/2×(1−|cos α|)

ΔΦ_{R}=Dsin α/2

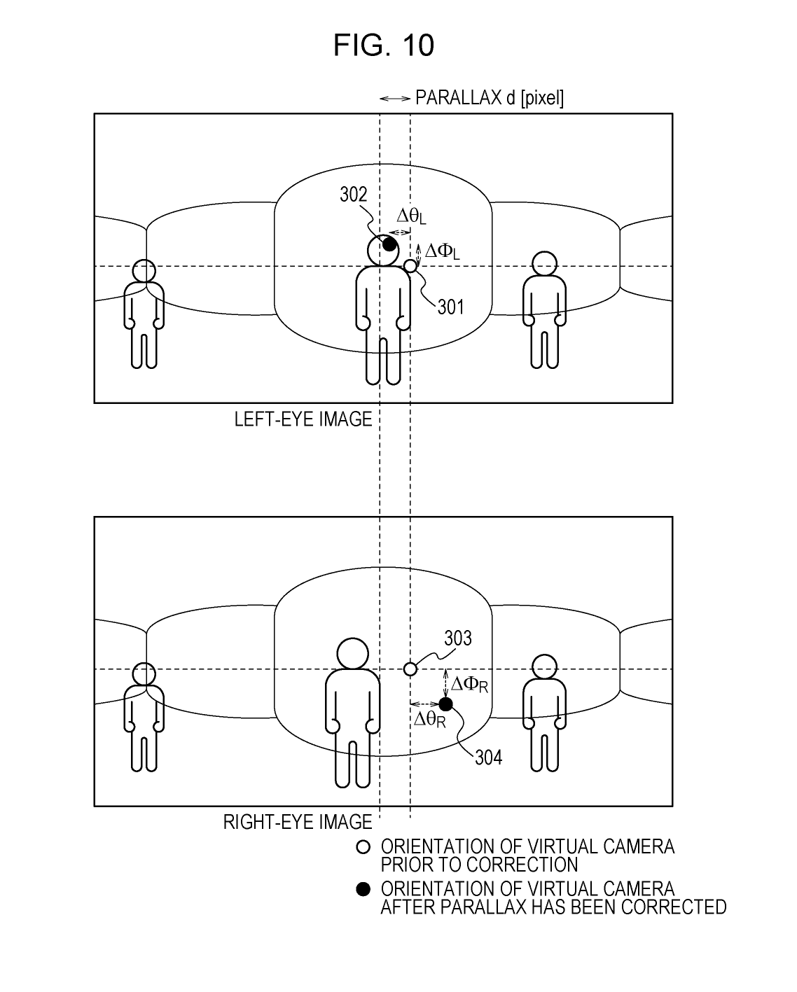

Here, the parallax amount D is obtained by converting the parallax amount d [pixel] on the 360-degree spherical image to the radian system of units, and D=d×2π/w holds. In the above, w is the width [pixel] of the 360-degree spherical image. In addition, Sign( ) is a signum function and returns 1 when the variable is greater than 0, 0 when the variable is 0, and −1 when the variable is smaller than 0. The amount of adjustment of the virtual cameras obtained here is converted to a rotation matrix, which yields M_{L} and M_{R}. The posture R_{L} of the left virtual camera and the posture R_{R} of the right virtual camera are each a rotation matrix obtained by applying M_{L} and M_{R} to the posture R of the display. An example of the orientation of the virtual cameras of which the postures have been adjusted is illustrated in FIG. 10.

### Posture Adjustment of Virtual Cameras

As illustrated in FIG. 10, the orientations of the virtual cameras prior to the adjustment are indicated by open circles 301 and 303 on the 360-degree spherical images, and the open circles 301 and 303 are on the same coordinates for the two eyes. Solid circles 302 and 304 indicate the orientations of the virtual cameras after the adjustment. In this manner, in one or more aspects of the present disclosure, the posture of the virtual camera for the right-eye image and the posture of the virtual camera for the left-eye image are adjusted in different directions. To be more specific, the right and left virtual cameras are adjusted to the positions (the positions of the solid circles 302 and 304) symmetric about the open circles 301 and 303 indicating the orientations of the virtual cameras held prior to the adjustment, and the distance between the right and left virtual cameras is equal to the parallax amount d.

Although the right and left virtual cameras are rotated by the same amount in the foregoing description, one or more aspects of the present disclosure is not limited to such an adjustment. It suffices that the amount of adjustment (the amount of shift) be the same in total between the right and left virtual cameras, and thus the amount of shift need not be equal between the right and left virtual cameras. For example, only the right virtual camera may be adjusted, or only the left virtual camera may be adjusted. In addition, the amount of adjustment of the postures may be adjusted by constant-multiplying the amount of adjustment by the number from 0 to 1.

When the parallax amount is small, the parallax mismatch arising when the roll occurs is also small, and thus the postures of the virtual cameras need not be adjusted. In that case, a threshold value dₜₕ of the parallax amount is determined in advance. Then, the postures of the virtual cameras are adjusted when the parallax amount is greater than the threshold value dₜₕ, and the postures of the virtual cameras are not adjusted when the parallax amount is smaller than the threshold value dₜₕ.

### Acquisition of Display Parameter

In S5, the display parameter acquiring unit 205 acquires, from the input device 107, an image display parameter, which is a parameter for displaying the parallax image in the output device 109. The image display parameter includes, for example, the focal length of the eyepiece lens of the head mounted display, the distortion parameter, the center position of the eyepiece lens on the display, the display resolution, and the display size. The display parameter acquiring unit 205 outputs the acquired image display parameter to the display image generating unit 206. Instead of acquiring the image display parameter from the input device 107, the display parameter acquiring unit 205 may acquire the image display parameter stored in the RAM 102 or the HDD 105 from the RAM 102 or the HDD 105.

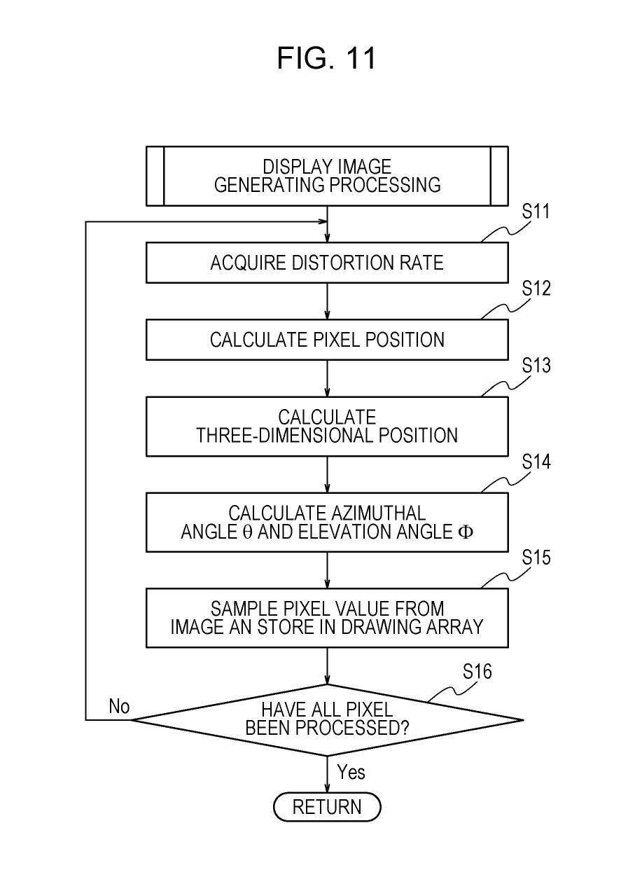

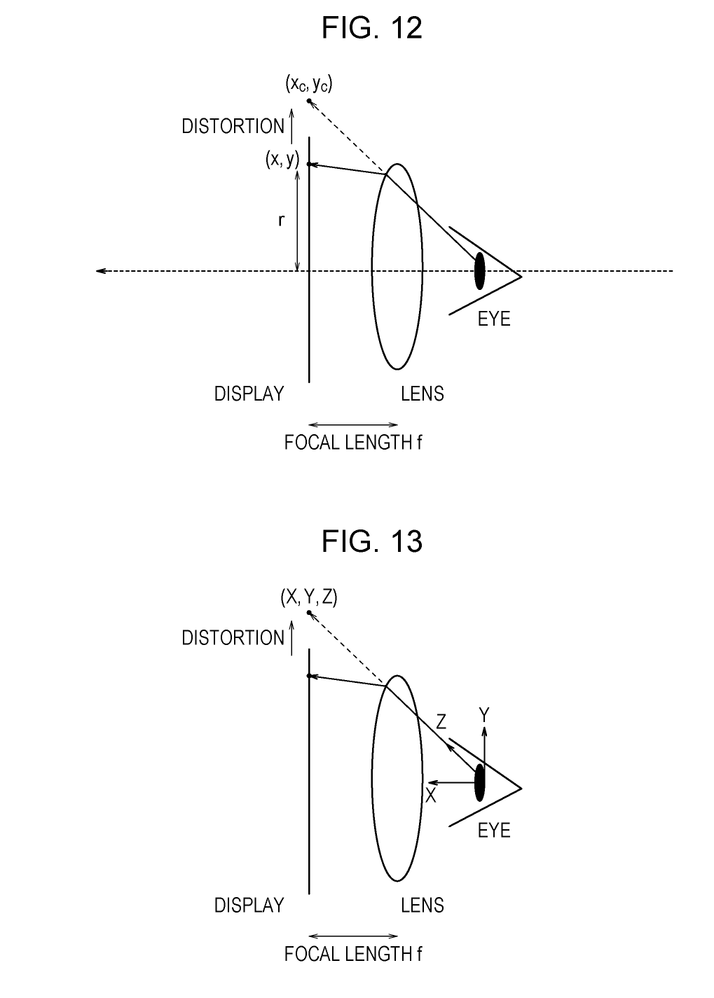

In S6, the display image generating unit 206 generates the display images to be displayed in the output device 109 from the image display parameter, the image data, and the posture information of the right and left virtual cameras. As illustrated in FIG. 5, the display images include the display image J_{L} to be presented to the left eye and the display image J_{R} to be presented to the right eye, and the display images J_{L} and J_{R} are images in which the distortion of the eyepiece lens has been corrected so that the display images can be viewed without distortion when viewed through the eyepiece lens. The details of this display image generating processing will be described later with reference to FIG. 11, FIG. 12, and FIG. 13. The display image generating unit 206 outputs the display images J_{L} and J_{R} to the image data output unit 207.

In S7, the image data output unit 207 outputs the display images J_{L} and J_{R} generated in S6 to the output device 109 in the form of image data and causes the display images J_{L} and J_{R} to be displayed on the display.

The processing proceeds to S8 from S7. In S8, it is determined whether the processing is to be terminated. If the determination in S8 is Yes, the image processing apparatus 113 terminates the processing. If the determination in S8 is No, the processing returns to S1.

### Display Image Generating Processing

The display images to be displayed in the head mounted display are generated by sampling the pixel values from the parallax image in accordance with the direction in which the head of the viewer (the wearer of the head mounted display) is tilted. In order to sample the pixel values from the parallax image, a light ray of which orientation is to be displayed at each pixel position on the display is calculated on the basis of the posture information of the right and left virtual cameras. The orientation of the light ray can be expressed by the azimuthal angle θ indicating the angle about the axis extending in the up and down direction and the elevation angle φ indicating the angle about the axis extending in the right and left direction. In the following description, the position of a pixel in the coordinate system with its origin lying on the center of the eyepiece lens is designated as (x,y), the orientation (θ,φ) of a light ray is calculated, and the pixel value in the display images is obtained from the calculated orientation.

The details of the display image generating processing will be described with reference to the flowchart illustrated in FIG. 11. The following processing is carried out on all the pixels in the right and left display images.

In S11, the display image generating unit 206 (FIG. 2) acquires the distortion rate of the eyepiece lens at a pixel position (x,y). The distortion rate will be described with reference to FIG. 12.

FIG. 12 illustrates an example of distortion on the image coordinates. The distortion rate is determined by the distance r from the center of the eyepiece lens and the optical characteristics of the eyepiece lens, and thus the display image generating unit 206 acquires the distortion rate from a lookup table of the distortion rates with respect to the distances r from the center of the eyepiece lens prepared in advance in accordance with the optical characteristics of the eyepiece lens. When the distortion rate differs at different wavelengths due to the optical characteristics of the eyepiece lens, a lookup table is prepared for each wavelength of R, G, and B of the display. Then, the display image generating unit 206 acquires the distortion rate for each of R, G, and B and carries out the processing by using the distortion rate that differs for each of R, G, and B in S12 and thereafter. R stands for Red, G stands for Green, and B stands for Blue.

A Lookup table may be created in advance so that the distortion rate can be referenced for each pixel position, and the calculation of the distance r from the center of the eyepiece lens may be omitted. In addition, when the distance r from the center of the eyepiece lens to a given pixel is large and the pixel is outside the area that can be viewed with the eyepiece lens, the pixel value in the display image may be set to black, and the processing on that pixel may be terminated.

In S12, the display image generating unit 206 calculates the pixel position from which it appears as if the light ray from the pixel position (x,y) is emitted due to the refraction caused by the distortion of the eyepiece lens. The calculated pixel position (x_{c},y_{c}) is referred to as a “distorted position” in the following description. The distorted position (x_{c},y_{c}) can be calculated by multiplying x and y in the pixel position (x,y) by the distortion rate c, as indicated in the expression (1).

x_{c}=x×c

y_{c}=y×c (1)

The distorted position (x_{c},y_{c}) is illustrated in FIG. 12.

In S13, the display image generating unit 206 converts the distorted position (x_{c},y_{c}) to a three-dimensional position (X,Y,Z) on the coordinate system with its origin lying at the position of the eye and thus calculates the three-dimensional position (X,Y,Z). An example of the relationship between a point on the image coordinates and a three-dimensional position is illustrated in FIG. 13. The posture information of the virtual cameras is represented by a 3×3 rotation matrix R, and the focal length expressed in units of pixels is designated as f. Then, the three-dimensional position (X,Y,Z) can be calculated through the following expression (2).

[XYZ]^{t}=R×[xyf]^{t} (2)

The posture of the virtual camera differs depending on whether the virtual camera is for the left-eye display image or for the right-eye display image. Thus, R in the expression (2) is replaced with R_{L} when the pixel value in the left-eye display image is obtained, and the R in the expression (2) is replaced with R_{R} when the pixel value in the right-eye display image is obtained.

In S14, the display image generating unit 206 calculates the azimuthal angle θ and the elevation angle φ from the three-dimensional position (X,Y,Z) of the pixel. FIG. 13 illustrates the relationship between the origin and the three-dimensional position. When the distance from the origin to (X,Y,Z) is L=(X²+Y²+Z²)^{1/2}, the azimuthal angle θ and the elevation angle φ can be calculated through the following expression (3).

φ=asin(Y/L)

θ=asin(Z/L/cos φ) (3)

In S15, the display image generating unit 206 acquires (samples) the pixel value of the light ray in the direction (θ,φ) from the corresponding image and stores the acquired pixel value into the corresponding pixel position in the display image. In other words, in S15, the display image generating unit 206 samples the pixel value of the light ray in the direction (θ,φ) from the corresponding image and stores the sampled pixel value into the drawing array. The pixel value is sampled from the left-eye image when the left-eye display image is generated, and the pixel value is sampled from the right-eye image when the right-eye display image is generated. The position at which the sampled pixel value is stored is the position moved from the origin by (x,y).

When the pixel value is sampled from the image, the nearest pixel value may be acquired, or the sampling may be carried out through interpolation, such as bilinear interpolation or bicubic interpolation, by using surrounding pixel values. In addition, when the roll angle α is |α|>90°, the positional relationship of the right and left eyes is inverted from that held when the roll angle α is |α|≤90°. Thus, the right and left display images may be switched. In other words, the pixel value for the left-eye display image may be sampled from the right-eye image, and the pixel value for the right-eye display image may be sampled from the left-eye image.

When the pixel value is sampled from an image other than a 360-degree spherical image (for example, an image captured by a fisheye camera or the like), a lookup table of the orientations (the azimuthal angles and the elevation angles) of the light rays stored in advance and the pixel positions corresponding thereto is prepared. The display image generating unit 206 acquires the pixel position (a,b) corresponding to the orientation (θ,φ) of a light ray from the stated lookup table, samples the pixel in the pixel position (a,b) of the image data, and stores the sample pixel onto the coordinates (x,y) of the display image, as in the case of the 360-degree spherical image.

After S15, in S16, it is determined whether all the pixels in the right and left display images have been processed. If not all the pixels have been processed, the processing returns to S11. If all the pixels have been processed, the processing returns to the flowchart illustrated in FIG. 3 and proceeds to S7.

### Advantageous Effects of the Present Disclosure

The display position of the display image is shifted after the display image is generated in Japanese Patent Laid-Open No. 2012-244453, which thus produces regions in the edges of the display (screen) in which the display image cannot be displayed by the amount by which the display image has been shifted, and the viewing angle is reduced. In addition, shifting the display image produces a mismatch between the center of the eyepiece lens and the center position in the distortion correction, and thus the distortion cannot be corrected properly. In contrast, according to one or more aspects of the present disclosure, the parallax mismatch is suppressed without reducing the viewing angle by adjusting the postures of the virtual cameras before the display images are generated. In addition, no mismatch is produced between the center of the eyepiece lens and the center position in the distortion correction, and thus the distortion can be corrected properly.

Accordingly, with the image processing apparatus 113 according to one or more aspects of the present disclosure, the parallax mismatch produced when the viewer tilts the head while the parallax image is displayed in the head mounted display is reduced, and an image with appropriate parallax in the region of interest can be displayed.

In the image processing apparatus 113 according to one or more aspects of the present disclosure, the postures of the virtual cameras are adjusted. Thus, the image processing apparatus 113 can be applied to the generation of display images from a 360-degree spherical image or a fisheye image, and the distortion can be corrected properly.

### Modifications

At least some of the functional blocks illustrated in FIG. 2A may be implemented by hardware. When some of the functional blocks are implemented by hardware, for example, a dedicated circuit may be generated automatically on FPGA from a program for implementing each step by using a predetermined compiler. In addition, in a similar manner to FPGA, a gate array circuit may be formed and implemented as hardware. In addition, some of the functional blocks may be implemented by ASIC. FPGA stands for Field-Programmable Gate Array. ASIC stands for Application Specific Integrated Circuit.

In the foregoing description, the CPU 101 executes the programs stored in the ROM 103 or the like to thus function as the functional blocks illustrated in FIG. 2A. Alternatively, the CPU 101 need not function as all the functional blocks. For example, a dedicated processing circuit corresponding to some of the functional blocks may be provided, and the functions of such functional blocks may be executed not by the CPU 101 but by the dedicated processing circuit.

Although the image processing apparatus 113 does not include the HDD 105, the input device 107, the output device 109, and the posture detecting device 111 in the foregoing description, the configuration of the image processing apparatus according to one or more aspects of the present disclosure is not limited to the above. For example, the image processing apparatus 113 may include at least one of the HDD 105, the input device 107, the output device 109, and the posture detecting device 111 as a constituent element of the image processing apparatus 113.

Although the HDD I/F 104 is included in the image processing apparatus 113 in the foregoing description, the image processing apparatus 113 need not include the HDD I/F 104 if the HDD 105 need not be used.

Although the terms “roll,” “pitch,” and “yaw” are used to express the posture in the foregoing description, another term, such as quaternion, may be used.

Although a 360-degree spherical image or an image captured by a fisheye camera has been illustrated as an example in the foregoing description, the present invention can be applied as long as a parallax image having an angle of view of no smaller than a predetermined value is viewed. Although a head mounted display has been illustrated as an example in the foregoing description, the present invention can also be applied to a display apparatus other than a head mounted display.

Although the posture detecting device 111 is mounted to the image display surface of the output device 109 or to the vicinity thereof in the foregoing description, the posture detecting device 111 may be mounted to a position other than the position described above as long as the posture detecting device 111 can detect the tilt of the display.

### Other Exemplary Embodiments

The present disclosure can also be implemented through processing in which a program that implements one or more functions of one or more aspects of the present disclosure described above is supplied to a system or an apparatus via a network or a storage medium and one or more processors in a computer of the system or the apparatus reads out and executes the program. In addition, the present disclosure can also be implemented by a circuit (for example, ASIC) that implements one or more functions.

### Other Embodiments

Embodiment(s) of the present disclosure can also be realized by a computerized configuration(s) of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computerized configuration(s) of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computerized configuration(s) may comprise one or more processors, one or more memories (e.g., central processing unit (CPU), micro processing unit (MPU)), and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2016-256606 filed Dec. 28, 2016, which is hereby incorporated by reference herein in its entirety.

What is claimed is:

1. An image processing apparatus configured to generate a display parallax image to be displayed in a display apparatus from each of a left-eye image and a right-eye image, the image processing apparatus comprising:
a first acquiring unit configured to acquire posture information of the display apparatus;
a second acquiring unit configured to acquire a parallax amount between the left-eye image and the right-eye image;
an adjusting unit configured to adjust a posture of each of a virtually disposed left-eye virtual camera and a virtually disposed right-eye virtual camera based on the posture information of the display apparatus and the parallax amount of the parallax image; and
a generating unit configured to generate the display parallax image from the left-eye image and the right-eye image based on adjusted postures of the virtual cameras.

2. The image processing apparatus according to claim 1,
wherein the posture information of the display apparatus is an amount of rotation of an image display surface of the display apparatus about an axis perpendicular to the image display surface.

3. The image processing apparatus according to claim 1,
wherein the adjusting unit adjusts the posture of the virtual camera for the right-eye image and the posture of the virtual camera for the left-eye image in different directions.

4. The image processing apparatus according to claim 1,
wherein the adjusting unit adjusts azimuthal angles of the virtual cameras in a horizontal direction of the virtual cameras and elevation angles of the virtual cameras in a vertical direction of the virtual cameras.

5. The image processing apparatus according to claim 4,
wherein the adjusting unit adjusts the elevation angles in a direction in which a mismatch in the display parallax image produced in a heightwise direction of the image display surface of the display apparatus is reduced.

6. The image processing apparatus according to claim 4,
wherein the adjusting unit adjusts the azimuthal angles such that a parallax amount in the display parallax image produced in a widthwise direction of the image display surface of the display apparatus becomes equal to a parallax amount produced in the display parallax image when the display apparatus is not tilted.

7. The image processing apparatus according to claim 4,
wherein the generating unit generates the display parallax image by sampling a pixel value from the left-eye image and the right-eye image on the basis of a table storing the azimuthal angles and the elevation angles corresponding to a pixel position in each of the left-eye image and the right-eye image.

8. The image processing apparatus according to claim 1,
wherein the adjusting unit refrains from adjusting the postures of the virtual cameras in a case in which the parallax amount is smaller than a predetermined threshold value.

9. The image processing apparatus according to claim 1,
wherein the second acquiring unit acquires a parallax amount in center regions in the left-eye image and the right-eye image as viewed through the virtual cameras.

10. The image processing apparatus according to claim 9,
wherein the second acquiring unit acquires the parallax amount by subjecting the center regions in the left-eye image and the right-eye image to matching processing.

11. The image processing apparatus according to claim 1,
wherein each of the left-eye image and the right-eye image is one of a 360-degree spherical image and an image captured by a fisheye camera.

12. The image processing apparatus according to claim 1,
wherein the generating unit generates the display parallax image by correcting distortion of a lens in the display apparatus.

13. The image processing apparatus according to claim 1,
wherein the display apparatus is a head mounted display.

14. The image processing apparatus according to claim 13,
wherein the generating unit generates the display parallax image by using an image display parameter of the display apparatus, and
wherein the image display parameter includes at least one of a focal length of an eyepiece lens in the head mounted display, a distortion parameter of the eyepiece lens, a center position of the eyepiece lens on the image display surface of the head mounted display, a resolution of the head mounted display, and a size of the image display surface.

15. The image processing apparatus according to claim 1,
wherein, in a case in which the posture information of the display apparatus indicates that the display apparatus is tilted in a horizontal direction, the adjusting unit rotates one of the left-eye virtual camera and the right-eye virtual camera downward and rotates the other one of the left-eye virtual camera and the right-eye virtual camera upward.

16. The image processing apparatus according to claim 15,
wherein, in a case in which the posture information of the display apparatus indicates that the display apparatus is tilted in the horizontal direction, the adjusting unit adjusts the posture of at least one of the left-eye virtual camera and the right-eye virtual camera to be brought closer to a direction of a line of sight of the other one of the left-eye virtual camera and the right-eye virtual camera.

17. The image processing apparatus according to claim 1,
wherein the left-eye image and the right-eye image are images each with an angle of view greater than that of the display parallax image.

18. An image processing method of generating a display parallax image to be displayed in a display apparatus from a left-eye image and a right-eye image, the image processing method comprising:
adjusting a posture of each of a virtually disposed left-eye virtual camera and a virtually disposed right-eye virtual camera based on posture information of the display apparatus and a parallax amount between the left-eye image and the right-eye image; and
generating the display parallax image from the left-eye image and the right-eye image based on adjusted postures of the virtual cameras.

19. The image processing method according to claim 18,
wherein, in a case in which the posture information of the display apparatus indicates that the display apparatus is tilted in a horizontal direction, one of the left-eye virtual camera and the right-eye virtual camera is rotated downward, and the other one of the left-eye virtual camera and the right-eye virtual camera is rotated upward.

20. A storage medium storing a program that causes a computer to execute an image processing method of generating a display parallax image to be displayed in a display apparatus from each of a left-eye image and a right-eye image, the image processing method comprising:
adjusting a posture of each of a virtually disposed left-eye virtual camera and a virtually disposed right-eye virtual camera based on the posture information of the display apparatus and the parallax amount of the parallax image; and
generating the display parallax image from the left-eye image and the right-eye image based on adjusted postures of the virtual cameras.
